(19) United States
(12) Patent Application Publication
(10) Pub. No.: US 2009/0009835 A1
(43) Pub. Date: Jan. 8, 2009

(54) Hologram Reproducer and Hologram Reproducing Method

(75) Inventors: Nobuhiro Kihara, Kanagawa (JP); Shigeyuki Baba, Tokyo (JP); Hisayuki Yamatsu, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/572,995

(22) PCT Filed: Sep. 12, 2005
(86) PCT No.: PCT/JP05/16724

§ 371 Date: Jan. 31, 2007

(30) Foreign Application Priority Data
Sep. 13, 2004 (JP) 2004-264864
Sep. 14, 2004 (JP) 2004-266703

(51) Int. Cl. G03H 1/22

(52) U.S. Cl. 359/32

(57) ABSTRACT

When a hologram recording material is changed in volume and refractive index during hologram recording, if one sheet of non-defective reconstructed images cannot be obtained even if conditions are changed so as to conform with Bragg's law most closely by changing the angle or position of a reference beam, a hologram reconstructing apparatus and a hologram reconstructing method are provided, in that a plurality of sheets of partially non-defective and favorable reconstructed images (51, 52, and 53) are obtained and favorable parts of these reconstructed images are connected together so as to have one sheet of non-defective and favorable reconstructed images (54).

### TECHNICAL FIELD

The present invention relates to a hologram reconstructing apparatus for reconstructing a hologram three-dimensionally recorded on a hologram recording material (hologram recording medium), and in particular it relates to a hologram reconstructing method for reconstructing the hologram by correcting the reconstructed image deterioration due to changes in volume and refractive index of the recording material during hologram recording.

### BACKGROUND ART

Recently, a hologram recording and reconstructing system has been proposed for recording and reconstructing a large amount of data using a holographic technique. The hologram recording and reconstructing system includes a recording system and a reconstructing system the recording system recording, on a hologram recording material (may be simply referred to as a recording material below) an interference fringe produced by irradiating the recording material with a signal beam including recording data produced by spatial light modulating means of a liquid crystal device, etc., and with a reference beam established correspondingly to the signal beam; and the reconstructing system reconstructing the data by irradiating the hologram recording material with the reference beam so as to produce diffraction light (a reconstruction signal beam) corresponding to the recorded interference fringe to be received by a receiving device, such as a CCD image sensor, for analyzing it. The recorded hologram per one spatial light modulating means is referred to as a page.

In the hologram recording and reconstructing system, a so-called multiple recording technique is used for improving a memory density. This is a technique in that a plenty of independent pages are recorded on one position differently from conventional optical disk recording. Typical known such multiple recording systems include angular multiple recording, shift multiple recording, phase encoding multiple recording, and other systems.

In the angular multiple recording system, a plenty of independent pages are recorded on and reconstructed from one position by changing the angle of the reference beam. The shift multiple recording is performed by gradually shifting the recording position. In the phase encoding multiple recording, when one page is recorded, the page is irradiated with the reference beams in various directions, simultaneously, for the recording. At this time, the phase of the reference beam in each direction is shifted, and by variously combining these phase shifts, a plenty of independent pages are recorded on and reconstructed from one position.

In the hologram recording material, especially in a photo-polymer material, the volume is changed due to the chemical reaction of the photosensitive material during recording or after the recording. It is known that this results in the deterioration of reconstructed images (Non-Patent Document: Holographic Data Storage; H. J. Coufal, D. Psaltis, G. T. Sincerbox E D; Springer; p. 185 (Photopolymer System)). The hologram recording and reconstructing made by two parallel beams will be described as an example of the volume change after the recording with reference to FIGS. 14A and 14B.

FIGS. 14A and 14B are drawings illustrating the case where the volume of a recording material is not changed. As shown in FIG. 15A, an interference fringe 60 formed of a signal beam 100 and a reference beam 200 is three-dimensionally recorded on a recording material 12. The interference fringe is illustrated as parallel beams in FIG. 14A; however, since the signal beams are not parallel in practice, the recorded interference fringe does not become parallel. When the volume of the recording material is not changed, as shown in FIG. 14B, the interference fringe 60 is not changed, so that if a reference beam 200′ a entered at the same angle of the reference beam 200 during recording, a reconstructed signal light 300 can be obtained in a desired direction. In this case, for the recorded images shown in FIG. 15A, favorable reconstructed images are obtained as shown in FIG. 15B.

Whereas, when the volume of the recording material is changed as shown in FIGS. 16A and 16B, the interference fringe 60 recorded on the recording material 12 deforms as shown in FIG. 16B by the shrinking (contracting) of the recording material 12. When the reference beam 200′ enters the recording material 12 changed in such a manner at the same angle as that of the reference beam 200 during recording the interference fringe recorded on the recording material 12 is not in conformity with Bragg's law. Thereby, for the recorded images shown in FIG. 17A, the whole reconstructed images do not become favorable as shown in FIG. 175, and the images may not be occasionally reconstructed.

### DISCLOSURE OF INVENTION

When images are recorded by the angular multiple system as mentioned above, if the volume or the refractive index of the recording material is changed, (1) the reference beam is out of conformity with Bragg's law due to the change in volume or refractive index so that the diffraction efficiency is reduced, darkening the images; (2) since the signal beam has an angle of view, the deviation from Bragg's law varies with each beam direction in the reconstructed images, so that the luminance becomes non-uniform as shown in the reconstructed images of FIG. 17D.

The present invention has been made in view of the situations described above, and it is an object thereof to provide a hologram reconstructing method and a hologram reconstructing apparatus capable of obtaining favorable reconstructed images similar to the recorded images without degradation even when the volume or the refractive index of a recording material is changed.

In order to achieve the object described above, in a hologram reconstructing apparatus for obtaining reconstructed images by irradiating a hologram recording material with a reference beam, the apparatus according to the present invention includes image obtaining means for obtaining a plurality of sheets of the same-page reconstructed images reconstructed from the hologram recording material; image cleaving means for cleaving respective predetermined characteristic parts of the obtained plurality of sheets of the reconstructed images; and image combining means for combining the cleaved predetermined characteristic parts of the reconstructed images into one sheet of the reconstructed images.

Also, in a hologram reconstructing method for obtaining reconstructed images by irradiating a hologram recording material with a reference beam, the method according to the present invention includes the steps of obtaining a plurality of sheets of the same-page reconstructed images reconstructed from the hologram recording material; and combining predetermined characteristic parts of the obtained respective reconstructed images into one sheet of the reconstructed images.

When the hologram recording material is changed in volume and refractive index during hologram recording, if one sheet of non-defective reconstructed images cannot be obtained even if conditions are changed so as to conform with Bragg's law most closely by changing the angle or position of a reference beam, according to the present invention by changing the incident angle and the irradiating position of the reference beam several times a plurality of sheets of partially non-defective and favorable the same-page images are obtained and favorable parts of these reconstructed images are connected together so as to have one sheet of non-defective and favorable reconstructed images. Specifically, when a plurality of pages of images recorded on the same position of the hologram recording material are obtained by changing the incident angle of the reference beam or by changing the irradiating position of the reference beam while the incident angle is maintained constant, by finely changing the incident angle or the irradiating position, a plurality of sheets of images recorded on the same position of the hologram recording material are obtained; predetermined parts of the obtained reconstructed images are determined by image processing; the determined predetermined parts are cleaved so as to combine the cleaved predetermined parts into one sheet of reconstructed images. Thereby, even when the recording material is changed in volume and refractive index during recording images by a multiple system favorable reconstructed images similar to the recorded images without deterioration can be obtained.

According to the present invention, when the hologram recording material is changed in volume and refractive index during hologram recording, if one sheet of non-defective reconstructed images cannot be obtained even if conditions are changed so as to conform with Bragg's law most closely by changing the angle or the irradiating position of a reference beam, by changing the angle or the irradiating position of the reference beam a plurality of times, a plurality of reconstructed images partially including non-defective and favorable parts are obtained; and the favorable parts of the reconstructed images are connected together by image combining so as to be able to have one sheet of non-defective and favorable reconstructed images. At this time, determination of the non-defective and favorable part (predetermined characteristic part) is made one time every change of the incident angle or the irradiating position of the reference beam, and thereafter, using this determined result, by cleaving a predetermined characteristic part of another page of reconstructed image, the image processing is accelerated. Alternatively, data of the relationship between the angle of the reference beam incident in the hologram recording material or the irradiating position thereof and the predetermined characteristic part of the reconstructed images are stored in advance, and using the stored data, by cleaving a predetermined characteristic part of reconstructed image/the same effect can be obtained.

### BRIEF DESCRIPTION OF THE DRAWINGS

FIG. 1 is a block diagram of a hologram reconstructing apparatus according to a first embodiment of the present invention.

FIG. 2 is a block diagram of the detailed configuration of the control unit shown in FIG. 1.

FIG. 3 includes drawings showing a reconstructed image example with respect to an angle of a reference beam during reconstruction in the apparatus shown in FIG. 1.

FIG. 4 includes drawings showing a reconstructed image example with respect to an angle of a reference beam during reconstruction in the apparatus shown in FIG. 1.

FIG. 5 includes drawings showing a reconstructed image example with respect to an angle of a reference beam during reconstruction in the apparatus shown in FIG. 1.

FIG. 6 is a drawing illustrating the image processing operation of the control unit shown in FIG. 1.

FIG. 7 is a drawing showing a target reconstructed image example during the image processing operation of the control unit shown in FIG. 1.

FIG. 8 is a block diagram of a hologram reconstructing apparatus according to a second embodiment of the present invention.

FIG. 9 is a block diagram of the detailed configuration of the control unit shown in FIG. 8.

FIG. 10A is a drawing illustrating a correcting method by finely changing an irradiating position of a reference beam, not an incident angle thereof, on a hologram recording material.

FIG. 10B is a drawing illustrating a correcting method by finely changing the irradiating position of the reference beam, not the incident angle thereof, on the hologram recording material.

FIG. 11A is a drawing showing a reconstructed image example of the same page with respect to the irradiating position of the reference beam on the hologram recording material.

FIG. 11B is a drawing showing a reconstructed image example of the same page with respect to the irradiating position of the reference beam on the hologram recording material.

FIG. 11C is a drawing showing a reconstructed image example of the same page with respect to the irradiating position of the reference beam on the hologram recording material.

FIG. 12 is a drawing illustrating the image processing operation of the control unit shown in FIG. 8.

FIG. 13 is a drawing showing a target reconstructed image example during the image processing operation of the control unit shown in FIG. 8.

FIG. 14A is a drawing illustrating the recording operation of a conventional hologram recording and reconstructing apparatus.

FIG. 14B is a drawing illustrating the recording operation of the conventional hologram recording and reconstructing apparatus.

FIG. 15A is a drawing showing a recorded image example of the conventional hologram recording and reconstructing apparatus.

FIG. 15B is a drawing showing a reconstructed image example of the conventional hologram recording and reconstructing apparatus.

FIG. 16A is a drawing showing the reconstructing operation of a hologram recoding material changed in volume or refractive index in the conventional hologram recording and reconstructing apparatus.

FIG. 16B is a drawing showing the reconstructing operation of the hologram recoding material changed in volume or refractive index in the conventional hologram recording and reconstructing apparatus.

FIG. 17A is a drawing showing a recorded image example of the conventional hologram recording and reconstructing apparatus.

FIG. 17B is a drawing showing a reconstructed image example of the conventional hologram recording and reconstructing apparatus.

### BEST MODE FOR CARRYING OUT THE INVENTION

### First Embodiment

First, a first embodiment obtaining a plurality of predetermined characteristic parts by changing an angle will be described.

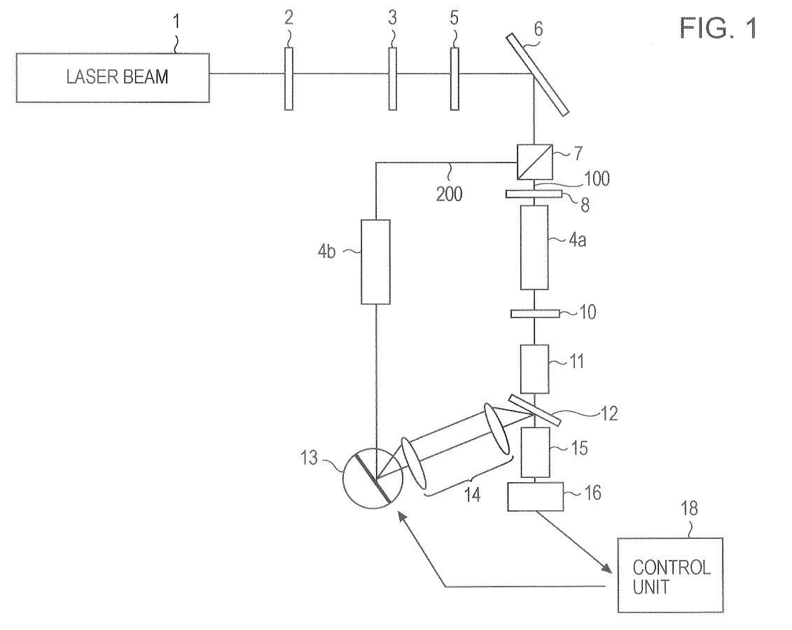

FIG. 1 is a block diagram of a hologram reconstructing apparatus according to the first embodiment of the present invention. The hologram (recording) reconstructing apparatus includes a laser light source 1, an ND filter 2, a half-wave plate 3, a beam expander for signal light 4a, a beam expander for reference light 4b, a shutter 5, a mirror 6, a polarization beam splitter 7, a shutter 8, a spatial light modulator 10, a signal light optical system 11, a rotating mirror 13, a reference light optical system 14, a reconstruction light optical system 15, an image-pickup device 16, and a control unit 18. The hologram recording reconstructing apparatus records images on a hologram recording material 12 and reconstructs images from the hologram recording material 12.

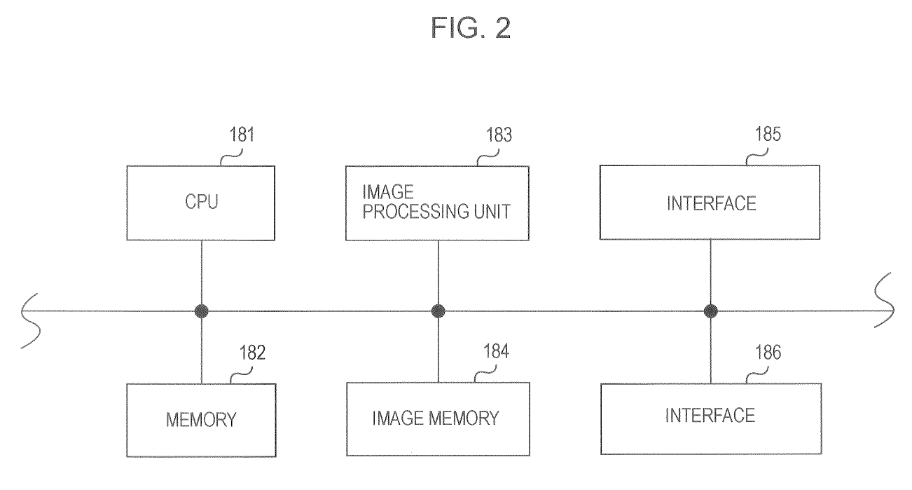

FIG. 2 is a block diagram of the detailed configuration of the control unit shown in FIG. 1. The control unit 18 includes a CPU 181, a memory 182, an image processing unit 183, an image memory 184, and interfaces 185 and 186. The interface 185 is connected to the image pickup device 16 shown in FIG. 1. The interface 186 is connected to a drive unit (not shown) of the rotating mirror 13. The CPU 181 controls the reflection angle of the rotating mirror 13 through the interface 186, and it inputs reconstructed image data from the image pickup device 16 into the apparatus through the interface 185. In addition, other than the normal angular-multiple recording and reconstructing data control, the control unit 18 has a control function to obtain a plurality of image sheets of the same page by finely changing the incident angle of the reference beam 200 to the hologram recording material 12, and to determine favorable parts of the obtained images with image processing so as to cleave a plurality of the obtained favorable parts for combining them into one image sheet.

Then, the operation according to the embodiment will be described. A coherent laser beam emitted from the laser light source 1 is adjusted in intensity by the ND filter 2; then, is inputted into the mirror 6 via the shutter 5 after its polarization plane is adjusted by the half-wave plate 3 so as to change its light path; and is bifurcated into a signal beam 100 and a reference beam 200 in the desired intensity ratio by the polarization beam splitter 7

The signal beam 100 is inputted into the beam expander for signal light 4a via the shutter 8 so as to be expanded into a collimated beam; and is inputted into the spatial light modulator 10. The signal beam 100 is modulated in intensity by the spatial light modulator 10 displaying a data page (a recorded image), and the modulated signal beam 100 is condensed to the hologram recording material 12 by the signal beam optical system 11. On the other hand, the reference beam 200 is inputted into the beam expander for reference light 4b so as to be expanded into a collimated beam; then, is inputted into the rotating mirror 13 capable of changing the angle of the reflection plane; and is inputted into the 4f-system reference light optical system 14 after its light path is changed by being reflected at a certain angle, and the reference beam 200 is condensed to the hologram recording material 12 by the reference light optical system 14. Thereby, the signal beam 100 is overlapped with the reference beam 200 within the hologram recording material 12 and the interference fringe formed as a result is recorded on the hologram recording material 12

At this time, if the angle of the reflection plane of the rotating mirror 13 is changed whenever the data page displayed on the spatial light modulator 10 is changed, the incident angle of the reference beam 200 to the hologram recording material 12 is changed, so that a plurality of data pages are recorded on the same recording area of the hologram recording material 12 in multiple layers.

In order to reconstruct the data recorded on the hologram recording material 12, a diffraction ray, generated by irradiating the hologram recording material 12 with the same reference beam as the reference beam 200 (referred herein to as the reference beam 200), is inputted into the reconstruction light optical system 15, so that the diffraction ray is focused on the image pickup device 16 by the reconstruction light optical system 15.

The image pickup device 16 photo-electrically converts the received diffraction ray, and the obtained received ray signal is reconstructed due to analysis as image data. During the reconstruction, in the same way as in the recording, by rotating the rotating mirror 13 so as to change the incident angle of the reference beam 200 to the hologram recording material 12, the image data recorded on one recording area in multiple layers can be sequentially reconstructed. During the recording, the control unit 18 controls various operations, such as the operation of the shutters 5 and 6, the changing of the reflection plane angle of the rotating mirror 13, and the displaying the recorded images on the spatial light modulator 10. During the reconstruction, the control unit 18 controls various operations, such as the operation of the shutters 5 and 6, the changing of the reflection plane angle of the rotating mirror 13, and the image processing of the combining the reconstructed images obtained from the image pickup device 16 if necessary.

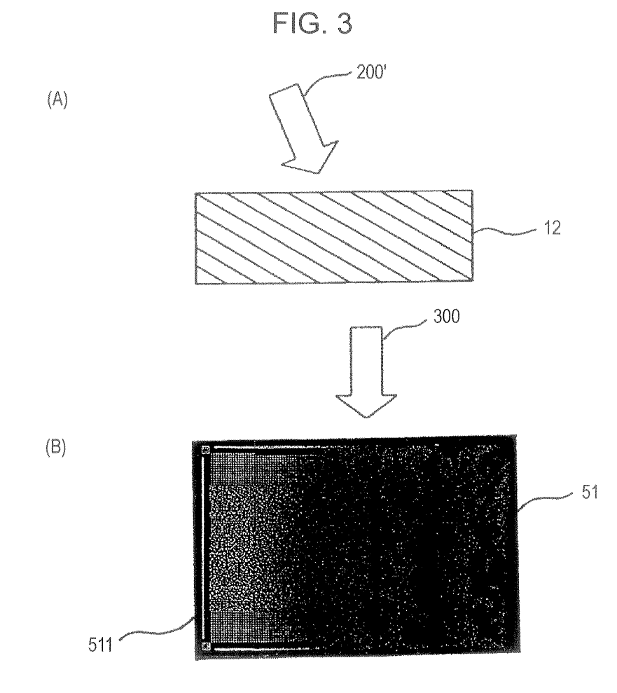

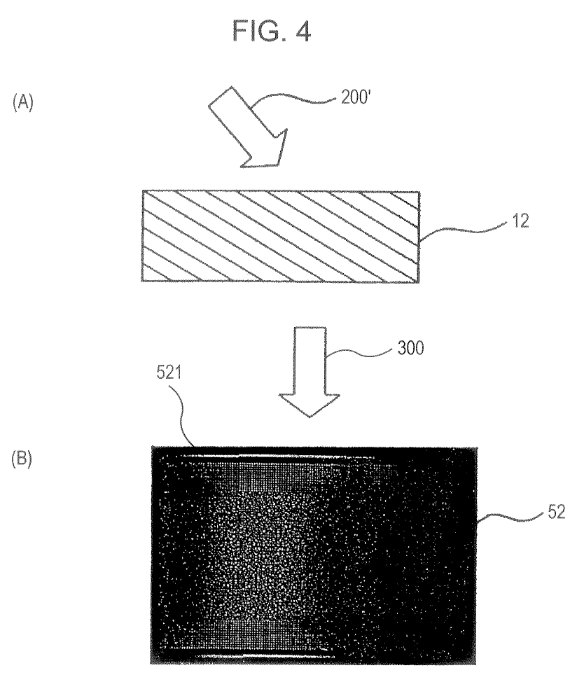

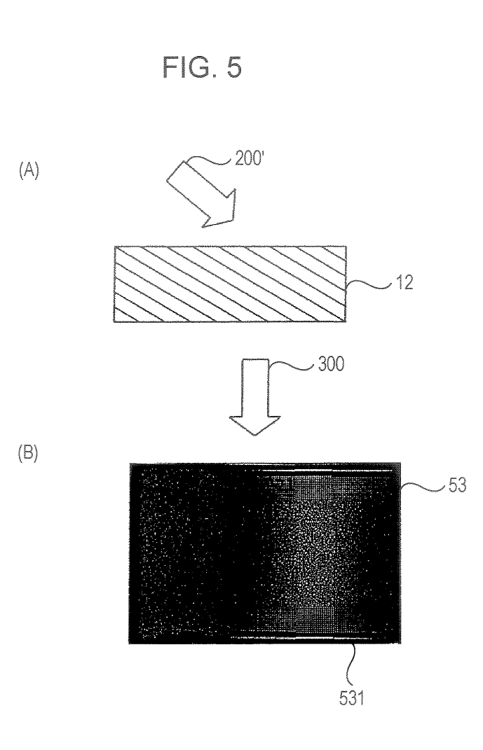

During the recording the recording images displayed on the spatial light modulator 10 on the hologram recording material 12 as described above, if the hologram recording material 12 is changed in volume or refractive index, the control unit 18 according to the embodiment, as shown in FIGS. 4(A) and 5(A), changes the incident angle of the reference beam 200′ to the hologram recording material 12 so as to generate a reconstructed signal beam 300 by changing the reflection angle of the rotating mirror 13. Thereby, the control unit 18 obtains the reconstructed images shown in FIGS. 3(B), 4(B), and 5(B) by receiving the reconstructed signal beam 300 with the image pickup device 16.

When the hologram recording material 12 is changed in volume or refractive index, the hologram recording material 12 is irradiated by adjusting the incident angle of the reference beam 200′ so that the incident angle comes to close to complying with Bragg's law as close as possible; however, since Bragg's law is different for each field angle of the signal beam image, as shown in FIGS. 3(B), 4(B), and 5(B) perfect reconstructed images cannot be obtained. That is, the reconstructed images can only be obtained, which partially include non-defective bright parts 511, 521, and 531 (favorably reconstructed parts equally to the original images).

That is, in the angular multiple hologram changed in volume or refractive index, only part of the reconstructed images comes close to complying with Bragg's law as close as possible so as to be reconstructed as favorable non-defective images. The control unit 18 determines between the favorably reconstructed part and the defective unfavorable part with the image processing so as to have one sheet of wholly favorable reconstructed images by splicing the favorable parts together.

Then, the control unit 18 according to the embodiment acquires a plurality of sheets of partially non-defective images as shown in reference numerals 51, 52, and 53 of FIG. 6 from the same page images so as to have one sheet of favorable non-defective images as shown in numeral 54 of FIG. 6 by combining non-defective parts of the plurality of the images together.

Then, the CPU 181 of the control unit 18 stores a plurality of the reconstructed images 51 to 53 shown in FIG. 6 into the image memory 184 from the image pickup device 16 while the angle of the reference beam 200′ incident in the hologram recording material 12 is changed by rotating the rotating mirror 13. Thereafter, the CPU 181 derives the reconstructed images in the image memory 184 one sheet after another so as to feed them to the image processing unit 183. The image processing unit 183 recognizes the favorable image range in the reconstructed images 51 to 53 so as to store the correspondent relationship between the incident angle of the reference beam 200′ and the position of the favorable image part into the memory 182.

A method for determining the favorable part of reconstructed images with the image processing includes: (1) determining by the brightness or the diffraction efficiency of each part of the images; (2) determining by the contrast ratio of each part of the images; and (3) determining by the noise amount of each part of the images. Then the CPU 181 derives only a favorable part of each reconstructed image from the image memory 184 with reference to the recognized results stored in the memory 182 so as to continuously connect these favorable parts together for combining one sheet of non-defective reconstructed images 54.

At this time, the image processing unit 183 derives each reconstructed image obtained from the image memory 184 in a column unit (with a width of one pixel, for example), while recognizing the diffraction efficiency (or the contrast ratio) of that part, so as to cleave the image range of the diffraction efficiency (or the contrast ratio) over a predetermined level as favorable image parts for combining one sheet of favorable non-defective images together by connecting the cleaved favorable image parts together. Alternatively, a plurality of the reconstructed images acquired to the image memory 184 may be entirely cleaved in a column unit (with a width of one pixel, for example) so as to collect reconstructed image parts with the diffraction efficiency (or the contrast ratio) over a predetermined level in a column unit from the reconstructed images for combining one sheet of non-defective reconstructed images together by making the original one sheet of the reconstructed images. In addition, the diffraction efficiency (or the contrast ratio) with the predetermined level may be a fixed value or values different for each part of the images. For example, although depending on the emission mode of the laser, basically, the central part of the page has a favorable reconstruction diffraction efficiency of the reconstructed light, while end portions of the page have unfavorable diffraction efficiency, due to the state during the recording. Then, the diffraction efficiency with the predetermined level is established according to Gaussian distribution, such that the level is high in the central part of the page of the image region compared in a column unit of the reconstructed images and it is low in end portions of the page. In such a manner, from the central part of the page, excellent reconstructed images are obtained while from the end portions of the page, there are scarcely constructed images eliminated for unsatisfying the predetermined diffraction efficiency. Also, the diffraction efficiency is not necessarily favorable depending on the emission mode of the laser. Then, when the diffraction efficiency with the predetermined level is established in a column unit in associated with the laser mode during the recording, the images can be reconstructed with higher accuracies.

According to the embodiment described above, the correspondent relationship between the reference beam 200 and the favorable part position of the reconstructed images is obtained for each reconstructed image (data page) with the image processing; however, this correspondent relationship is not only effective for one sheet of the reconstructed images but is normally effective for other reconstructed images. Hence, after the correspondent relationship of one reconstructed image is obtained for storing it into the memory 182 in the apparatus, the favorable part of other-page reconstructed images may also be cleaved using this correspondent relationship. When the above-mentioned correspondent relationship is measured at first, if the correspondent relationship is obtained by reconstructing the prepared measuring data page (data page having patterns facilitating the measuring the diffraction efficiency and the contrast ratio) the measuring accuracy can be improved.

According to the embodiment, if the hologram recording material 12 is changed in volume and refractive index during the hologram recording, when one sheet of non-defective reconstructed images cannot be obtained even if the incident angle comes to close to complying with Bragg's law to the utmost by changing the angle of the reference beam 200′, a plurality of sheets of the reconstructed images 51 to 53 partially having favorable non-defective images are obtained so that one sheet of favorable non-defective images 54 can be obtained by the image combination which connects these favorable parts together.

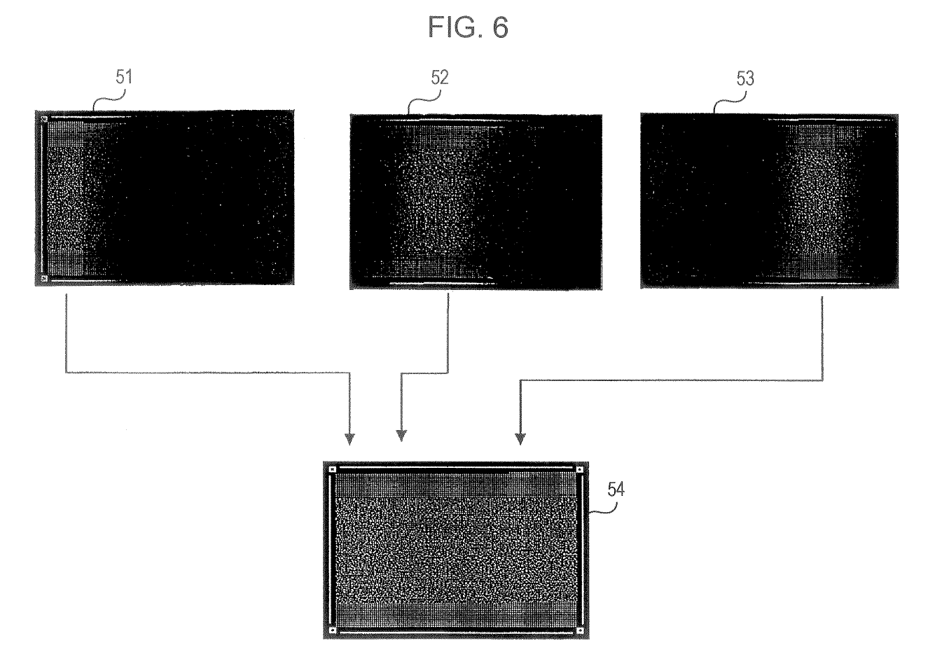

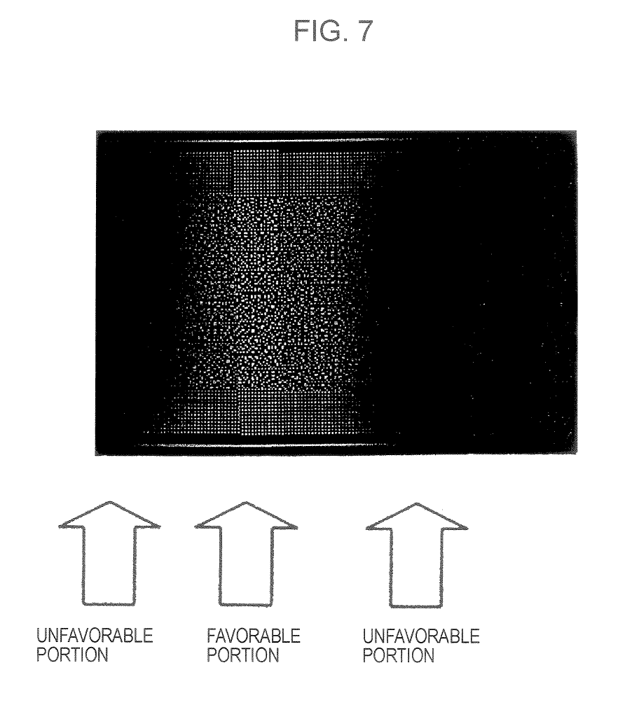

The above-mentioned correspondent relationship between the angle of the reference beam and the position of the favorable image part favorably reconstructed on one sheet of reconstructed images as shown in FIG. 7 can also be obtained theoretically. Thereby, this correspondent relationship is stored into the memory 182 of the control unit 18 in advance, and during the hologram reconstruction, the one sheet of favorable non-defective images 54 can also be obtained using the correspondent relationship data stored in the memory 182. However, since a variation parameter, such as temperature changes between those during recording and during reconstruction, is included in the theoretical values, it is necessary to measure the temperature of the hologram recording material 12 during the reconstruction, if the parameter is the temperature for example, and further to measure the temperature during the recording if necessary so as to record it on the hologram recording material 12.

### Second Embodiment

Next, a second embodiment obtaining a plurality of predetermined characteristic parts by changing the irradiating position of the reference beam will be described.

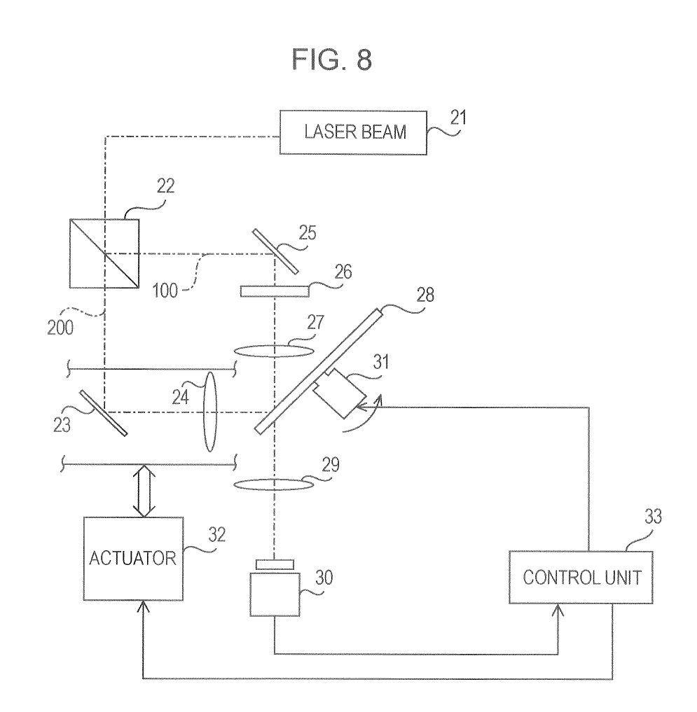

FIG. 8 is a block diagram of the configuration of a hologram reconstructing apparatus according to the second embodiment. The hologram reconstructing apparatus for performing the hologram record by the shift multiple system includes a laser light source 21, a polarization beam splitter 22, a mirror 23, a Fourier lens 24, a mirror 25, a spatial light modulator 26, a Fourier lens 27, a hologram recording material 28, an inverse Fourier lens 29, an image-pickup device 30, a spindle motor 31, an actuator 32, and a control unit 33 such as a personal computer. The control unit 33, other than the normal shift multiple control, controls processes of finely changing the position of a reference beam while maintaining the incident angle thereof; obtaining a plurality of sheets of the same-page images every time when the reference beam is finely changed; determining and cleaving a predetermined characteristic part of the obtained images; and combining the obtained a plurality of predetermined characteristic parts into one sheet of reconstructed images.

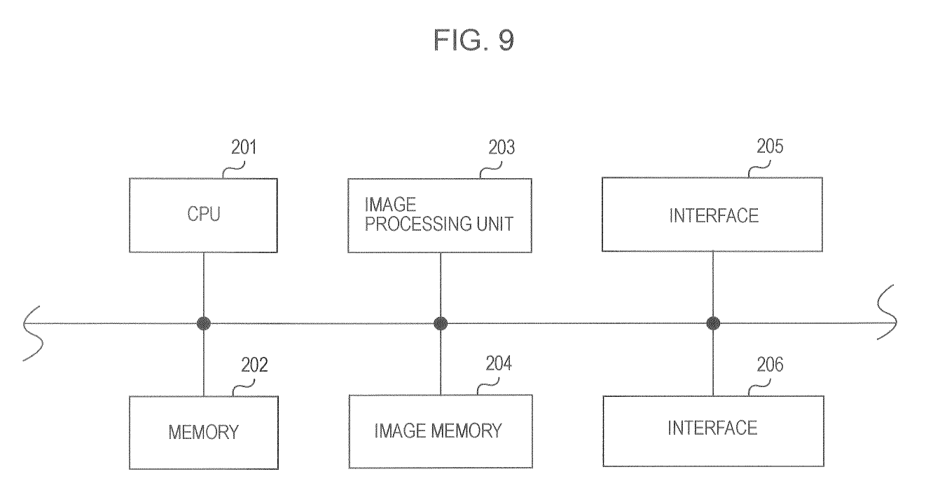

FIG. 9 is a block diagram of the detailed configuration of the control unit shown in FIG. 8. The control unit 33 includes a CPU 201, a memory 202, an image processing unit 203, an image memory 204, and interfaces 205 and 206. The interface 205 is connected to the image pickup device 30 shown in FIG. 8. The interface 206 is connected to the actuator 32. The CPU 201 controls the movement of the reference light optical system through the interface 206, and it inputs reconstructed image data from the image pickup device 30 into the apparatus through the interface 205.

Then, the operation according to the embodiment will be described. During recording, after a data page to be recorded is displayed on the spatial light modulator (permeable liquid crystal display) 26, a coherent laser beam emitted from the laser light source 21 enters the polarization beam splitter 22 so as to be bifurcated into a signal beam 100 and a reference beam 200. The signal beam 100 is spatial-light-modulated (modulated in intensity) by passing through the spatial light modulator 26 displaying the data page. The modulated signal beam 100 is condensed on the recording area of the hologram recording material 28 by the Fourier lens 27. On the other hand, the reference beam 200, after its traveling direction is changed by the mirror 23, is irradiated by the Fourier lens 24 so as to intersect with the signal beam 100 at a predetermined angle in the hologram recording material 28 for generating the interference fringe. The above-mentioned data page is recorded on the hologram recording material 28 as a refractive index distribution according to the spatial distribution of the interference fringe.

After one sheet of the hologram is recorded, the control unit 33 moves the hologram recording material 28 relatively to the optical system by a predetermined distance so as to record the next hologram by controlling the spindle motor 31. In this case, the disk-like hologram recording material 28 is rotated at a predetermined angle every time when one sheet of the hologram recording material 28 is recorded by the spindle motor 31. When the hologram recording material 28 has been fully rotated around the circle, the optical system or the hologram recording material 28 is moved radially for recording again in the peripheral direction of the material. By repeating these processes, many holograms are recorded over the entire surface of the hologram recording material 28.

When the hologram recorded in such a manner is reconstructed, the hologram recording material 28 is irradiated from the same position with the reference beam (reference beam) 200 having the same incident angle. Thereby, a diffraction ray is generated so as to correspond to the interference fringe recorded on the recording track of the hologram recording material 28. This diffraction ray is condensed on an image pickup element in the image pickup device 30 by the inverse Fourier lens 29 so that the received signal obtained is analyzed for becoming the original image data (data page).

When the hologram recording material 28 is changed in volume or refractive index during recording, even if the hologram recording material 28 is irradiated with the same reference beam as the reference beam 200 for the recording described above, Bragg's law is not conformed, so that the diffraction efficiency is reduced, obtaining only dark reconstructed images. In such a case, the control unit 33 performs a series of operations for correcting the change in volume or refractive index described as follows.

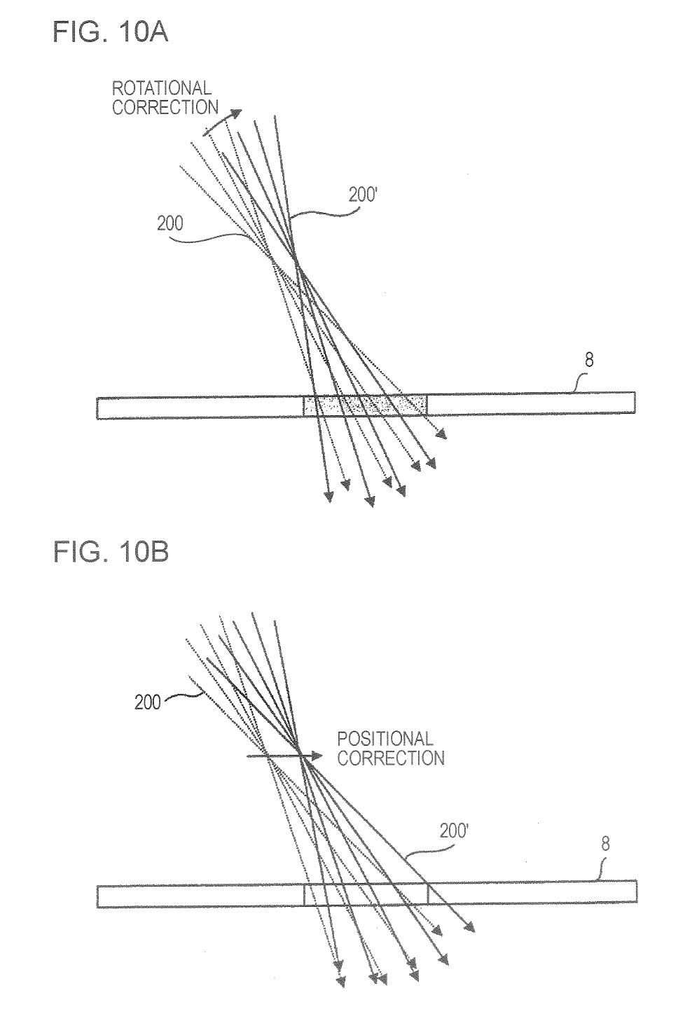

When the reference beam is non-parallel light such as in spherical wave shift multiple recording speckle multiple recording or phase encoding multiple recording, if the hologram recording material (recording material) is changed in volume or refractive index, the image quality of reconstructed images is deteriorated due to out of conformity with Bragg's law as described above. For correcting this deterioration according to the second embodiment, as shown in FIG. 10A tire angle of the reference beam 200′ incident in the hologram recording material 28 is finely changed; whereas, according to the embodiment, as shown in FIG. 10B, the irradiating position of the reference beam 200′ on the hologram recording material 28 is finely chanced from that during the recording. Thereby, at least part of the reconstructed images can be approximately conformed to Bragg law. This is because the angular change of the reference beam can be equivalently replaced with the positional change.

The positional moving method of the reference beam includes only a case where the entire reconstructed images are conformed to Bragg's law in an allowable ranges so that the case where only part of the reconstructed image is conformed to Bragg's law cannot be applied to the method as described above. Even in such a case, when the reconstructed images are viewed while the reference beam 200′ is moved, a favorable part being conformed to Bragg's law changes with the movement of the reference beam in fact. The correcting method according to the present invention is made by applying this fact.

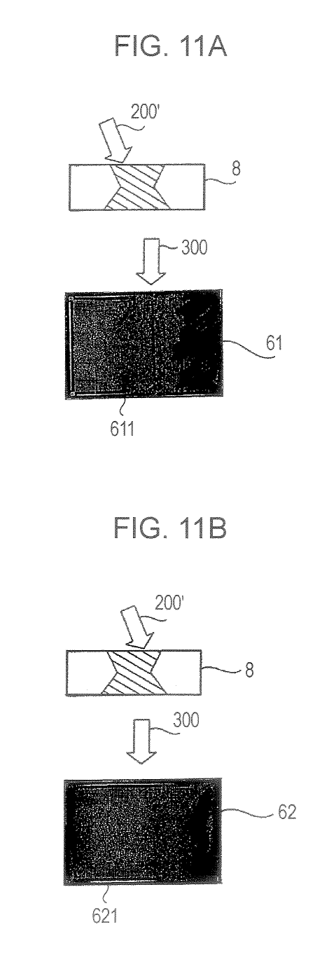

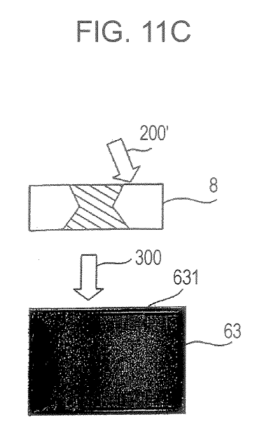

When the recorded images displayed on the spatial light modulator 26 are recorded on the hologram recording material 28 as described above, if the hologram recording material 28 is changed in volume or refractive index, the control unit 33 according to the embodiment moves the reference light optical system in a plane direction of the hologram recording material by a micro distance so as to move the irradiating position of the reference beam 200′ on the hologram recording material 28 by a micro distance as shown in FIGS. 11A to 11C by controlling the actuator 32. Thereby, the control unit 33 obtains reconstructed images 61, 62, and 63 shown in FIGS. 11A to 11C from the image pickup device 30. Although these images have non-defective bright parts 611, 621, and 631 (favorably reconstructed parts equal to the original images), any of these is not perfectly reconstructed images.

That is, in the shift multiple hologram changed in volume or refractive index, only parts of reconstructed images are reconstructed as favorable and non-defective images most close to the conformity with Bragg's law. The control unit 33 determines between a favorably reconstructed part and a defective unfavorable part with image processing so as to have one sheet of wholly favorable images by connecting only favorable parts together.

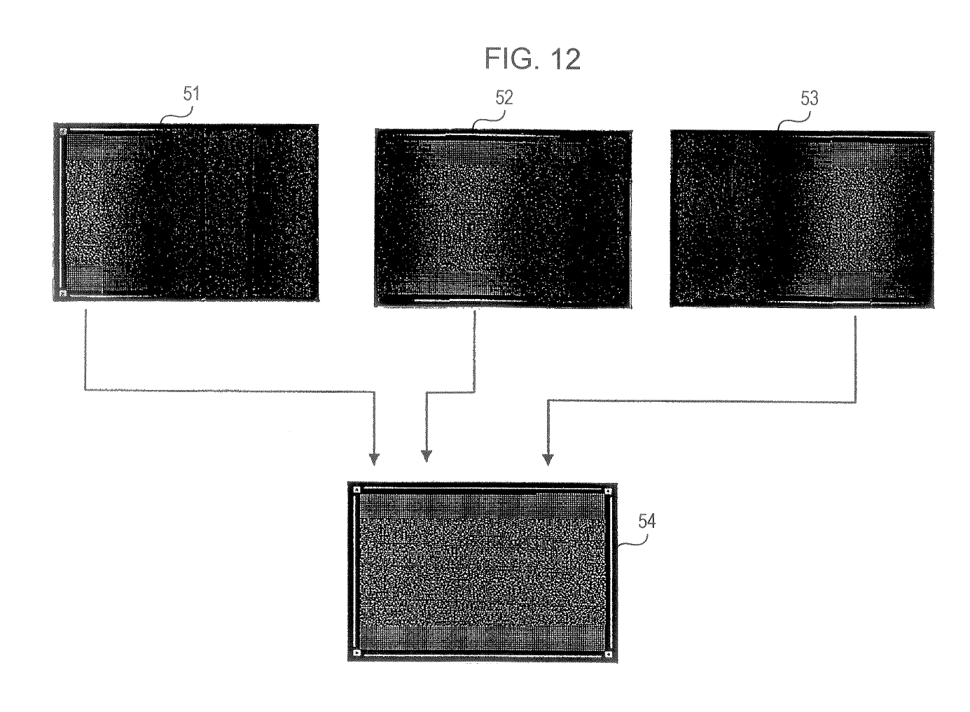

Then, the control unit 33 obtains a plurality of sheets of partially non-defective images as shown in the reconstructed images 51, 52, and 53 of FIG. 12 so as to have one sheet of favorable and non-defective images as shown in the reconstructed images 54 of FIG. 12 by combining non-defective parts of the plurality of the images together.

That is, the CPU 201 of the control unit 33 stores a plurality of the reconstructed images 51 to 53 shown in FIG. 5 into the image memory 204 from the image pickup device 30 while the position of the reference beam 200′ on the hologram recording material 12 is changed by moving the reference light optical system by controlling the actuator 32. Thereafter, the CPU 201 derives the reconstructed mages in the image memory 204 one sheet after another so as to feed them to the image processing unit 203. The image processing unit 203 recognizes the favorable image range in the reconstructed images 51 to 53 so as to store the correspondent relationship between the irradiating position of the reference beam 200′ and the position of the favorable image part into the memory 202.

A method for determining the favorable part of reconstructed images with the image processing includes: (1) determining by the brightness or the diffraction efficiency of each part of the images; (2) determining by the contrast ratio of each part of the images; and (3) determining by the noise amount of each part of the images. Then, the CPU 201 derives only a favorable part of each reconstructed image from the image memory 204 with reference to the recognized results stored in the memory 202 so as to continuously connect these favorable parts together for combining one sheet of non-defective reconstructed images 54.

At this time the image processing unit 203 derives each reconstructed image obtained from the image memory 204 in a column unit (with a width of one pixel, for example), while recognizing the diffraction efficiency (or the contrast ratio) of that part, so as to cleave the image range of the diffraction efficiency (or the contrast ratio) over a predetermined level as favorable image parts for combining one sheet of favorable non-defective images together by connecting the cleaved favorable image parts together. Alternatively, a plurality of the reconstructed images acquired to the image memory 204 may be entirely cleaved in a column unit (with a width of one pixel, for example) so as to collect reconstructed image parts with the diffraction efficiency (or the contrast ratio) over a predetermined level in a column unit from the reconstructed images for combining one sheet of non-defective reconstructed images together by making the original one sheet of the reconstructed images.

In addition, the diffraction efficiency (or the contrast ratio) with the predetermined level may be a fixed value or values different for each part of the images. For example, although depending on the emission mode of the laser, basically, the central part of the page has a favorable reconstruction diffraction efficiency of the reconstructed light, while end portions of the page have unfavorable diffraction efficiency, due to the state during the recording. Then, the diffraction efficiency with the predetermined level is established according to Gaussian distribution, such that the level is high in the central part of the page of the image region compared in a column unit of the reconstructed images and it is low in end portions of the page.

In such a manner, from the central part of the page, excellent reconstructed images are obtained while from the end portions of the page, there are scarcely constructed images eliminated for unsatisfying the predetermined diffraction efficiency. Also, the diffraction efficiency is not necessarily favorable depending on the emission mode of the laser. Then, when the diffraction efficiency with the predetermined level is established in a column unit in associated with the laser mode during the recording, the images can be reconstructed with higher accuracies.

According to the embodiment described above, the correspondent relationship between the irradiating position of the reference beam 200′ and the favorable part position of the reconstructed images is obtained every reconstructed image (data page) with the image processing; however, this correspondent relationship is not only effective for one sheet of the reconstructed images but is normally effective for other reconstructed images. Hence, after the correspondent relationship of one reconstructed image is obtained for storing it into the memory 202 in the apparatus, the favorable part of other-page reconstructed images may also be cleaved using this correspondent relationship. When the above-mentioned correspondent relationship is measured at first, if the correspondent relationship is obtained by reconstructing the prepared data page (data page having patterns facilitating the measuring the diffraction efficiency and the contrast ratio), the measuring accuracy can be improved.

According to the embodiment, if the hologram recording material 12 is changed in volume and refractive index during the hologram recording, when one sheet of non-defective reconstructed images cannot be obtained even if the incident angle comes to close to complying with Bragg's law to the utmost by changing the angle of the reference beam 200′, a plurality of sheets of the reconstructed images 51 to 53 partially having favorable non-defective images are obtained so that one sheet of favorable non-defective images 54 can be obtained by the image combination which connects these favorable parts together.

According to the embodiment, the shift multiple hologram recording reconstructing apparatus has been described as an example incorporating the present invention; alternatively, an angular multiple system, a speckle multiple system using a reference beam having a random wave front, or a phase encoding multiple system may be applied to the present invention so as to have the same advantages.

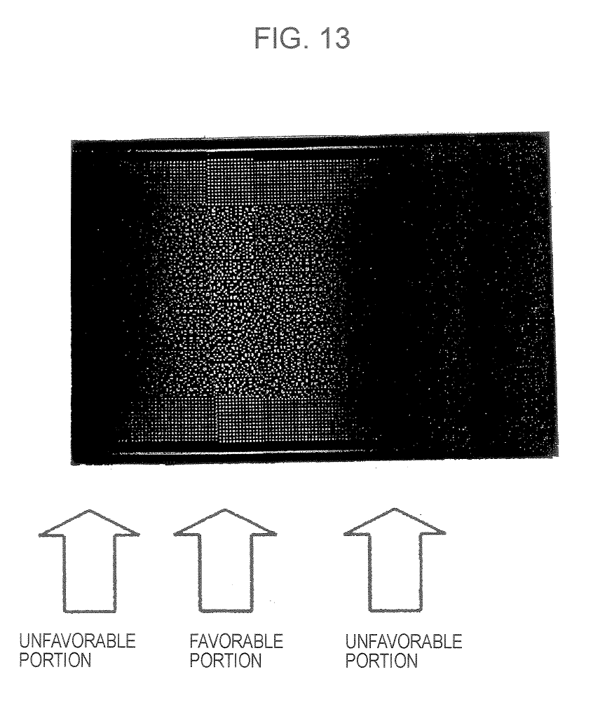

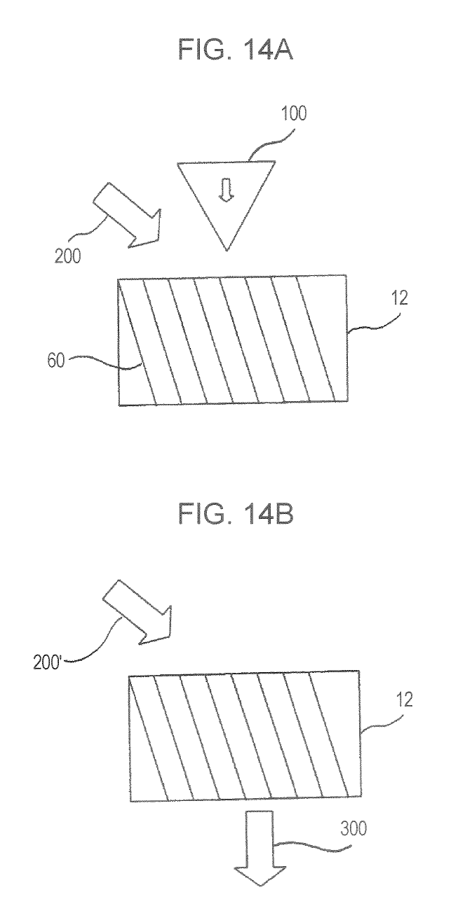

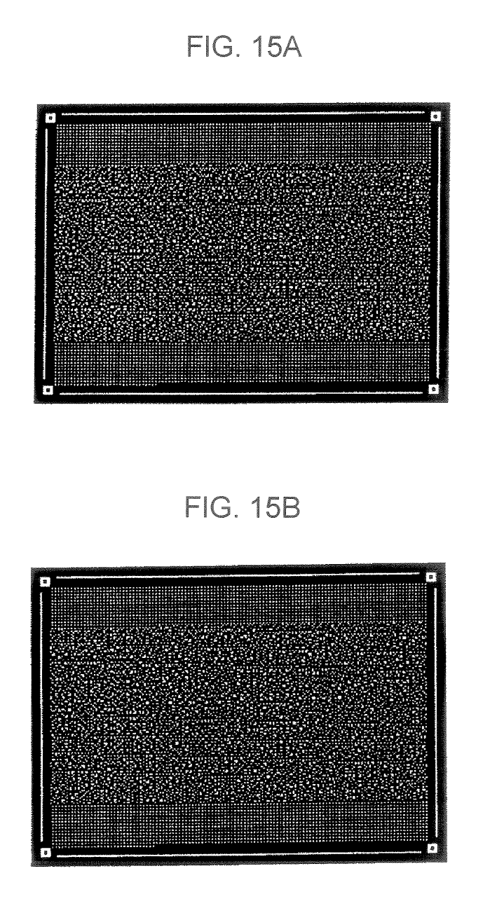

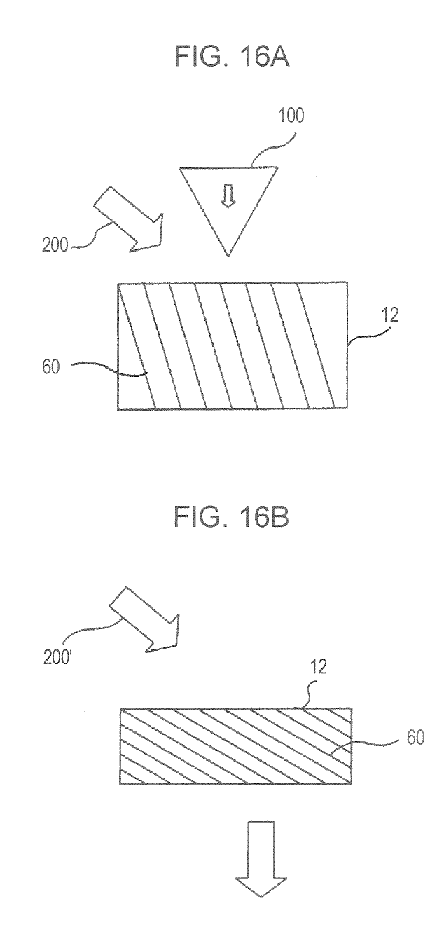

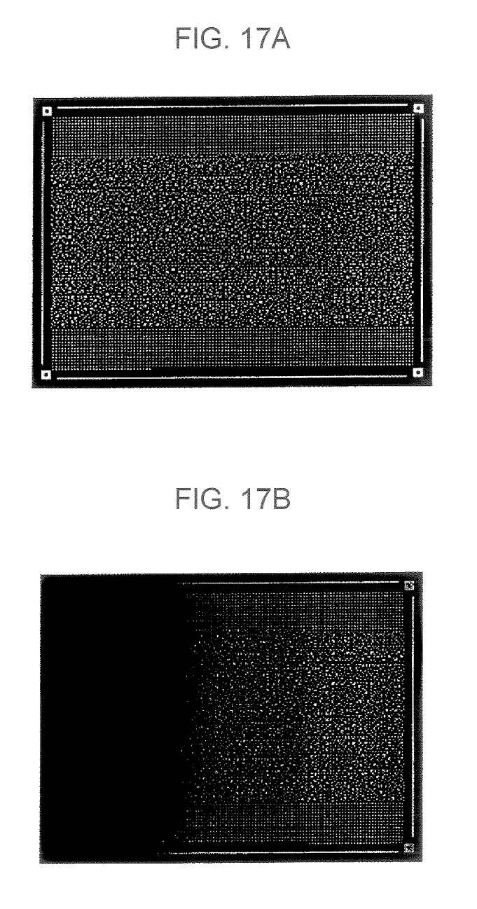

The above-mentioned correspondent relationship between the irradiating position of the reference beam′ and the position of the favorable image part favorably reconstructed on one sheet of reconstructed images as shown in FIG. 13 can also be obtained theoretically. Thereby, this correspondent relationship is stored into the memory 202 of the control unit 33 in advance, and during the hologram reconstruction, the one sheet of favorable non-defective images 54 can also be obtained using the correspondent relationship data stored in the memory 202. However, since a variation parameter such as temperature changes between those during recording and during reconstruction, is included in the theoretical values at this time, it is necessary to measure the temperature of the hologram recording material 12 during the reconstruction, if the parameter is the temperature for example, and further to measure the temperature during the recording if necessary so as to record it on the hologram recording material 28.

According to the embodiment described above, the positional movement of the reference beam 200′ is made by moving the reference light optical system; alternatively, when the hologram recording material is moved while the reference light optical system is fixed, the same effect can be obtained.

In addition, the present invention is not limited to conformations of the embodiments described above, and other various modifications in specific configurations, functions, operations, and effects can also be made, which fall within the spirit and scope of the invention. For example/according to the embodiments described above, the correction of the reconstructed image against changes in volume and refractive index of the recording material has been only described; however, the method according to the embodiments is also effective for differences in wavelength of the reference beam (laser beam) and in temperature of the hologram recording material between those of during recording and during reconstructing, which cause the deviation from Bragg's law. Therefore, the method can correct a plurality of factors causing the deviation from Bragg's law collectively so as to have favorable reconstructed images.

1. A hologram reconstructing apparatus for obtaining reconstructed images by irradiating a hologram recording material with a reference beam, comprising:
image obtaining means for obtaining a plurality of sheets of the same-page reconstructed images reconstructed from the hologram recording material;
image cleaving means for cleaving respective predetermined characteristic parts of the obtained plurality of sheets of the reconstructed images; and
image combining means for combining the cleaved predetermined characteristic parts of the reconstructed images into one sheet of the reconstructed images.

2. The apparatus according to claim 1, further comprising incident angle changing means for changing the angle of the reference beam incident to the hologram recording material,
wherein the image obtaining means obtains a plurality of sheets of the same-page reconstructed images reconstructed from the hologram recording material every time when the incident angle of the reference beam is changed.

3. The apparatus according to claim 1, further comprising position changing means for changing the irradiating position of the hologram recording material with the reference beam while the incident angle of the reference beam is maintained,
wherein the image obtaining means obtains a plurality of sheets of the same-page reconstructed images reconstructed from the hologram recording material every time when the irradiating position of the reference beam is changed.

4. The apparatus according to claim 1, further comprising storing means for storing the data in advance showing the relationship between an angle of the reference beam incident in the hologram recording material and a predetermined characteristic part position of reconstructed images,
wherein the cleaving means cleaves the predetermined characteristic part of the reconstructed images for each of the obtained incident angle, on the basis of the stored data.

5. The apparatus according to claim 1, further comprising determining means for determining a predetermined characteristic part of the obtained reconstructed images,
wherein when the determining means once determines a predetermined characteristic part of the reconstructed images for each incident angle, the image cleaving means cleaves a predetermined characteristic part of another-page reconstructed images thereafter using the determined result.

6. The apparatus according to claim 1, wherein the determining means determines whether each image region, which is formed by dividing the whole reconstructed images into columns, each having an one-pixel width, has a predetermined characteristic part, and
wherein the image combining means collects only the image regions determined to have the predetermined characteristic part so as to combine them into one sheet of reconstructed images.

7. The apparatus according to claim 1, wherein a contrast ratio or a diffraction efficiency of the predetermined characteristic parts of the reconstructed images has a value equal to or more than a predetermined threshold value.

8. The apparatus according to claim 5, wherein a threshold value is established for each image region, which is formed by dividing the reconstructed images into columns.

9. The apparatus according to claim 1, wherein threshold values are established every image region, which is formed by dividing the reconstructed images into columns, such that the threshold value in the central portion of the page is established to be high in comparison with those in end portions of the page.

10. The apparatus according to claim 1, wherein a threshold value is established every image region, which is formed by dividing the reconstructed images into columns, in accordance with the laser mode during recording.

11. The apparatus according to claim 1, wherein the determining means determines whether the reconstructed images have a predetermined characteristic every image region, which is formed by dividing the reconstructed images into columns.

12. The apparatus according to claim 1, wherein the width of an image region, which is formed by dividing the reconstructed images into columns, is at least one pixel.

13. The apparatus according to claim 1, wherein image data are recorded on the hologram recording material in angular multiple layers.

14. A hologram reconstructing apparatus for obtaining reconstructed images by irradiating a hologram recording material with a reference beam, comprising:
storing means for storing data of the relationship between an angle of the reference beam incident in the hologram recording material and a predetermined characteristic part position of reconstructed images in advance;
incident angle changing means for changing the angle of the reference beam incident in the hologram recording material;
image obtaining means for obtaining a plurality of sheets of the same-page reconstructed images reconstructed from the hologram recording material every time when the incident angle of the reference beam is changed;
image cleaving means for cleaving the predetermined characteristic part of the reconstructed images obtained every incident angle on the basis of the stored data; and
image combining means for combining the cleaved predetermined characteristic parts of the reconstructed images into one sheet of reconstructed images.

15. A hologram reconstructing apparatus for obtaining reconstructed images by irradiating a hologram recording material with a reference beam, comprising:
incident angle changing means for changing an angle of the reference beam incident in the hologram recording material;
image obtaining means for obtaining reconstructed images reconstructed from the hologram recording material every time when the incident angle of the reference beam is changed;
first incident angle controlling means for controlling the incident angle changing means such that the image obtaining means obtains other images recorded on the same position of the hologram recording material by changing the incident angle of the reference beam at a predetermined angle;
second incident angle controlling means for controlling the incident angle changing means such that the image obtaining means obtains the same-page images recorded on the same position of the hologram recording material by changing the incident angle of the reference beam at an angle smaller than the predetermined angle;
determining means for determining a predetermined characteristic part of the reconstructed images obtained by the image obtaining means for each of the incident angle when the incident angle changing means is controlled by the second incident angle controlling means;
image cleaving means for cleaving the predetermined characteristic part, which is determined, of the reconstructed images obtained every incident angle; and
image combining means for combining the cleaved predetermined characteristic parts of the reconstructed images into one sheet of reconstructed images.

16. The apparatus according to claim 12, further comprising determined result storing means for storing the result determined by the determining means that determines the predetermined characteristic part of the reconstructed images for each of the incident angle,
wherein when the determined result is stored by the determined result storing means, the image cleaving means cleaves a predetermined characteristic part of the other reconstructed images using the determined result.

17. A hologram reconstructing method for obtaining reconstructed images by irradiating a hologram recording material with a reference beam, the method comprising the steps of:
obtaining a plurality of sheets of the same-page reconstructed images reconstructed from the hologram recording material; and
combining predetermined characteristic parts of the obtained respective reconstructed images into one sheet of the reconstructed images.
